(19) United States
(12) Patent Application Publication
(10) Pub. No.: US 2003/0141476 A1
(43) Pub. Date: Jul. 31, 2003

(54) Connection between an armature and a valve needle of a fuel injection valve

(76) Inventor: Thomas Sebastian, Stuttgart (DE)

Correspondence Address: KENYON & KENYON, ONE BROADWAY, NEW YORK, NY, 10004, US

(21) Appl. No.: 10/220,231

(22) PCT Filed: Dec. 22, 2001
(86) PCT No.: PCT/DE01/04928

(30) Foreign Application Priority Data
Dec. 28, 2000 (DE) 100 65 528.9

(51) Int. Cl. F16K 31/02

(52) U.S. Cl. 251/129.19; 251/129.21

(57) ABSTRACT

A fuel injector (1), in particular for direct injection of fuel into the combustion chamber of an internal combustion engine having fuel mixture compression and spark ignition, includes an armature (20) which cooperates with a solenoid (10), and a valve needle (3) connected to the armature (20), on which valve needle a valve-closure member (4) is provided which together with a valve-seat surface (6) forms a sealing seat. The valve needle (3) passes through the armature (20) and an extension (15) formed on the armature (20) in such a way that a pin (32) may be inserted into a bore (34) in the extension (15) of the armature (20), whose alignment coincides axially and radially with a bore (35) in the valve needle (3), so that an axial pre-lift gap (30) is formed between the armature (20) and the valve needle (3).

### BACKGROUND INFORMATION

The present invention is directed to a fuel injector according to the definition of the species in the main claim.

Fuel injectors, which are preferably suited for the direct injection of fuel into the combustion chamber of an internal combustion engine, may have free armature travel or a pre-lift in order to improve the dynamic actuating properties of the fuel injector. The parts which this requires are in most cases connected, for example, to the valve needle by a non-positive connection, using preassembly followed by welding. Such fuel injectors are known, for example, from German Patent Application 198 49 210 A1 or U.S. Pat. No. 5,299,776.

One particular disadvantage of this method is that by pushing a sleeve for example onto the valve needle, chips can be scraped off, causing damage to both the valve needle and the sleeve, together with contamination of the interior of the valve. In addition, when the individual parts are welded, stresses occur depending on various factors such as the material thickness of the parts, the materials used, or the welding parameters: The result is great variances in the free armature travel or the height of the pre-lift gap. Both factors can result later in malfunctioning during operation of the fuel injector.

### ADVANTAGES OF THE INVENTION

The fuel injector according to the present invention, having the characterizing features of the main claim, has the advantage over the related art that a pre-lift of the armature may be regulated very precisely with little effort or expense using a pin which may be inserted into boreholes in the valve needle and the armature.

Advantageous refinements of and improvements to the fuel injector shown in the main claim are possible through the measures recited in the subclaims.

It is of particular advantage that the valve needle contains both a pre-lift spring and a regulating sleeve for the pre-lift spring in a cutout, making a very space-saving design of the free armature travel possible.

Advantageously, the pre-lift spring is positioned between the pin and the regulating sleeve in such a way that the free armature travel is independent of the pre-tensioning of the pre-lift spring.

Also of advantage is the possibility of inserting the hardened pin into the holes in such a way that the latter are calibrated by the pin, and the pre-lift may be regulated by a freely choosable offset of the pin.

### DRAWING

One exemplary embodiment of the present invention is depicted in simplified form in the drawing and explained in greater detail in the following description.

FIG. 1 shows a schematic sectional view, through an exemplary embodiment of a fuel injector designed according to the present invention, and

FIG. 2 shows a schematic detail in Area II of the fuel injector designed according to the present invention in FIG. 1.

### DESCRIPTION OF THE EXEMPLARY EMBODIMENT

A fuel injector 1 is designed in the form of a fuel injector for fuel injection systems of internal combustion engines having fuel mixture compression and spark ignition. Fuel injector 1 is especially suitable for direct injection of fuel into a combustion chamber (not shown) of an internal combustion engine.

Fuel injector 1 is made of a nozzle body 2 in which a valve needle 3 is situated. Valve needle 3 is mechanically linked to a valve-closure member 4, which cooperates with a valve-seat surface 6 situated on a valve-seat member 5 to form a sealing seat. Fuel injector 1 is an inwardly opening fuel injector 1 which has a spray-discharge orifice 7.

Nozzle body 2 is preferably connected to a stationary pole 9 of a solenoid 10 by welding. Solenoid 10 is encapsulated in a coil housing 11 and wound onto a field spool 12, which is in contact with an internal pole 13 of solenoid 10. Internal pole 13 and stationary pole 9 are separated from each other by a gap 26 and are supported on a connecting component 29. Solenoid 10 is energized by an electric current that may be supplied through an electric plug-in contact 17 via a line 19. Plug-in contact 17 is enclosed by plastic sheathing 18, which may be extruded onto internal pole 13.

In the present embodiment, valve needle 3 is designed as a hollow cylinder and has a central cutout. Fuel is conducted to the sealing seat by flow-through orifices 14 in the wall of valve needle 3. Valve needle 3 passes through an armature 20 which cooperates with solenoid 10, through a cutout 33, armature 20 being positioned on the outflow side of internal pole 13.

Supported on armature 20 is a return spring 23, which in the present design of fuel injector 1 is pretensioned by a sleeve 24. Return spring 23 exerts a force on armature 20 through the free armature travel design described below in such a way that valve-closure member 4 is held in sealing contact against valve-seat surface 6.

Armature 20 has on its outflow side a sleeve-shaped extension 15 through which valve needle 3 also passes. Extension 15 and valve needle 3 have radial through bores 34, 35 on the outflow side of armature 20, into which a pin 32 may be inserted radially.

The fuel, which is fed in through a central fuel supply 16 and filtered through a filter element 25, is conducted through a fuel channel 31, cutout 8 of valve needle 3, and via flow-through orifices 14 to spray-discharge orifice 7. Fuel injector 1 is sealed from a distribution line (no further details shown) by a gasket 28.

Between an adjusting sleeve 21, which may be inserted into cutout 8 of valve needle 3, and pin 32, a pre-lift spring 22 is positioned, which applies force to armature 20 through pin 32 in such a way that in the resting state of fuel injector 1 armature 20 is held in contact on an outflow-side end 36 of radial bore 35 of valve needle 3. Bore 35 of valve needle 3 has a slightly larger diameter than bore 34 of extension 15 of armature 20. Pre-lift spring 22 is brought to a freely adjustable pre-tension by adjusting sleeve 21. Adjusting sleeve 21 may optionally terminate with the inflow-side end of valve needle 3, or may extend beyond the latter in order to thereby provide a guide for return spring 23.

When solenoid 10 is energized, it builds up a magnetic field which moves armature 20 in the direction of lift against the elastic force of pre-lift spring 22 and return spring 23. The lift of armature 20 is divided into a pre-lift, whose purpose is to close a pre-lift gap 30, and an opening lift. The opening lift and the pre-lift together produce the total lift, which is predefined by a working gap 27 present between internal pole 12 and armature 20 in the rest position. The axial height of pre-lift gap 30 is defined by the slightly larger diameter of bore 35 in valve needle 3 compared to bore 34 in extension 15 of armature 20. After pre-lift gap 30 is closed, armature 20 rests against an inlet-side face 37 of bore 35 of valve needle 3.

After performing the pre-lift against the force of pre-lift spring 22, armature 20 entrains these parts in the direction of lift by means of extension 15 and pin 32 which passes through valve needle 3. Valve-closure member 4, which is mechanically linked to valve needle 3, lifts off valve-seat surface 5, causing the fuel which is conducted to spray-discharge orifice 7 through cutout 8 in valve needle 3 and through flow-through orifices 14 to be injected.

When the coil current is turned off, after the magnetic field has decayed sufficiently, armature 20 drops back from internal pole 13 due to the pressure of return spring 23, causing valve needle 3 to move against the direction of lift. That causes valve-closure member 4 to come to rest on valve-seat surface 6, and fuel injector 1 is closed.

In addition to improving the opening dynamics, pre-lift spring 22 produces a damping effect against bouncing of valve needle 3 in the sealing seat as fuel injector 1 closes. When valve-closure member 4 comes to rest on valve-seat surface 6, there can be a brief lifting of valve-closure member 4 from the sealing seat again. Pre-lift spring 22 retards the associated movement of valve needle 3 in the direction of lift, since damping occurs due to pin 32 inserted into bore 35 and the free armature travel thus established, and also because of the inhibition due to the mass of armature 20.

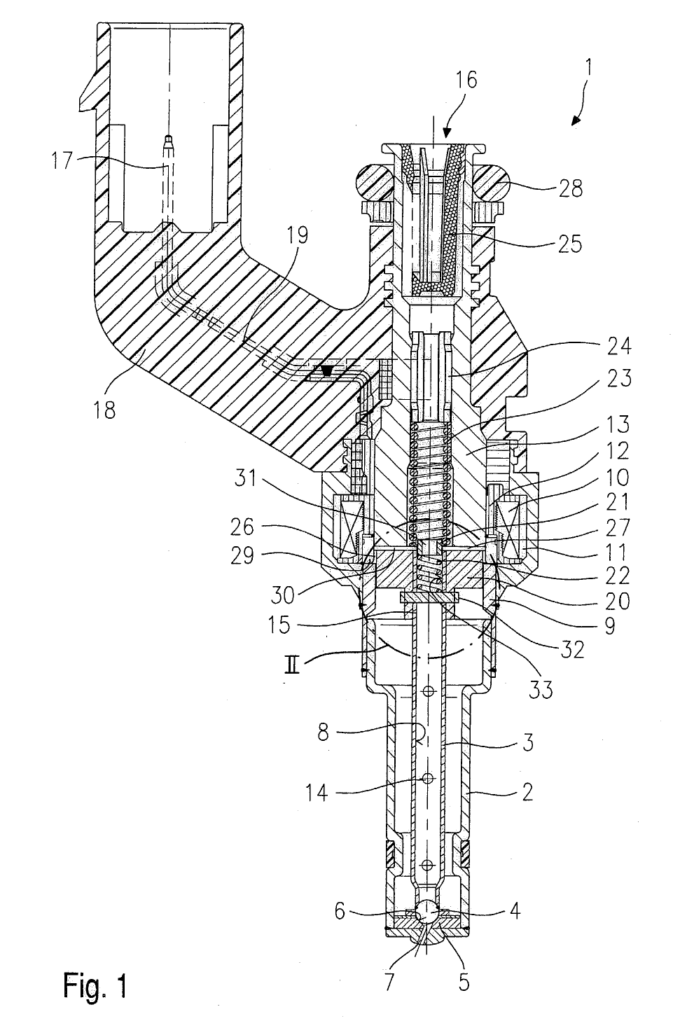

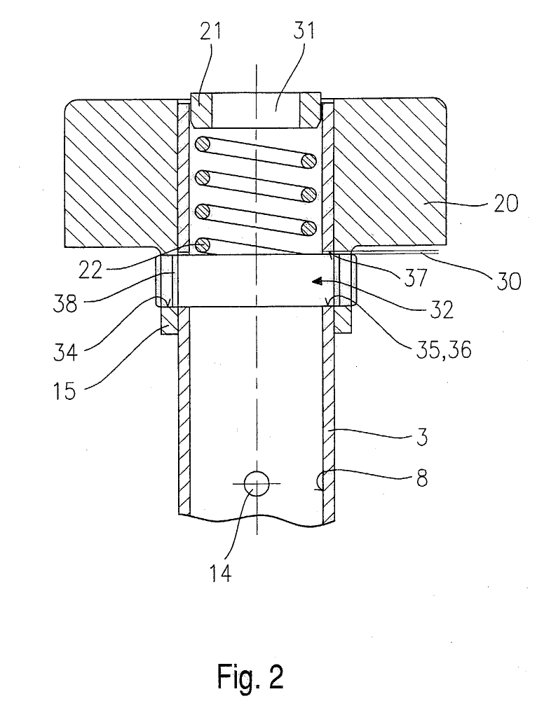

FIG. 2 shows a partial sectional view of the detail of the fuel injector 1 designed according to the present invention, designated with II in FIG. 1. Corresponding components have corresponding reference symbols in all figures.

In FIG. 2, the difference between the diameters of bore 34 in the extension of armature 20 and in valve needle 3 are readily recognizable. As mentioned earlier, the free armature travel or pre-lift is exactly the difference between the diameters of bore 34 of extension 14 and bore 35 of valve needle 3.

Bores 34 and 35 are preferably produced with armature 20 and valve needle 3 in the pre-installed state, so that no radial misalignments can occur between bores 34 and 35. Afterward bore 35 of valve needle 3 may be enlarged by any desired amount in order to set the pre-lift.

As an alternative to this option, pin 32 may also have a shoulder 38 whose size determines the pre-lift, while bores 34 and 35 have the same diameter. In this case, pin 32 may then be pressed specifically into bores 34 and 35, this being supported preferably by different degrees of hardness of the materials used. If pin 32 is hardened and valve needle 3 and extension 15 are soft compared to it, i.e. unhardened, pin 32 can be pressed into bores 34 and 35, so that a positive closure is achieved. Bores 34 and 35 are calibrated to the diameter of pin 32 by the aforementioned shoulder 38, so that only shoulder 38 of pin 32 produces the length of the free armature travel.

Whether bores 34 and 35 differ in size or pin 32 is pressed in, in each case the pre-lift depends on only one manufacturing step, so that bores 34, 35 or pin 32 are not dependent on additional manufacturing tolerances. Thus extremely precise regulation of the pre-lift is ensured, which is in particular not dependent on the pre-tensioning of pre-lift spring 22 or the axial position of adjusting sleeve 21.

The present invention is not limited to the exemplary embodiment depicted, and may also be used for other forms of armatures 20, for example for solenoid plungers and flat armatures, as well as for any desired designs of fuel injectors.

What is claimed is:

1. A fuel injector (1), in particular for the direct injection of fuel into the combustion chamber of an internal combustion engine having fuel mixture compression and spark ignition, comprising an armature (20) which cooperates with a solenoid (10), and a valve needle (3) which is connected to the armature (20) and on which a valve-closure member (4) is provided, which, together with a valve-seat surface (6), forms a sealing seat,
wherein the valve needle (3) passes through the armature (20) and an extension (15) formed on the armature (20), a pin (32) being positioned in a bore (34) in the extension (15) of the armature (20), whose alignment coincides with that of a bore (35) in the valve needle (3), in such a way that there is an axial pre-lift gap (30) between the armature (20) and the valve needle (3).

2. The fuel injector as recited in claim 1,
wherein a pre-lift spring (22) is positioned in a cutout (8) of the valve needle (3).

3. The fuel injector as recited in claim 1 or 2,
wherein the pre-lift spring (22) is supported by the pin (32).

4. The fuel injector as recited in one of claims 2 or 3,
wherein the pre-lift spring (22) is pre-tensioned by an adjusting sleeve (21).

5. The fuel injector as recited in claim 4,
wherein the adjusting sleeve (21) is insertable into the cutout (8) of the valve needle (3).

6. The fuel injector as recited in one of claims 1 through 5,
wherein the extension (15) is manufactured in one piece with the armature (20).

7. The fuel injector as recited in one of claims 1 through 6,
wherein the pin (32) has a shoulder (38).

8. The fuel injector as recited in one of claims 1 through 7,
the pin (32) is made of a hardened material.

9. The fuel injector as recited in claim 7,
the pin (32) may be pressed into the bores (34, 35) in such a way that the pre-lift gap (30) is set by the shoulder (38).
